(19) United States
(12) Patent Application Publication
(10) Pub. No.: US 2012/0143611 A1
(43) Pub. Date: Jun. 7, 2012

(54) Trajectory Tiling Approach for Text-to-Speech

(75) Inventors: Yao Qian, Beijing (CN); Zhi-Jie Yan, Beijing (CN); Yi-Jian Wu, Beijing (CN); Frank Kao-Ping Soong, Beijing (CN)

(73) Assignee: Microsoft Corporation, Redmond, WA (US)

(21) Appl. No.: 12/962,543

(22) Filed: Dec. 7, 2010

(51) Int. Cl. G10L 13/00

(52) U.S. Cl. 704/260; 704/E13.001

(57) ABSTRACT

Hidden Markov Models HMM trajectory tiling (HTT)-based approaches may be used to synthesize speech from text. In operation, a set of Hidden Markov Models (HMMs) and a set of waveform units may be obtained from a speech corpus. The set of HMMs are further refined via minimum generation error (MGE) training to generate a refined set of HMMs. Subsequently, a speech parameter trajectory may be generated by applying the refined set of HMMs to an input text. A unit lattice of candidate waveform units may be selected from the set of waveform units based at least on the speech parameter trajectory. A normalized cross-correlation (NCC)-based search on the unit lattice may be performed to obtain a minimal concatenation cost sequence of candidate waveform units, which are concatenated into a concatenated waveform sequence that is synthesized into speech.

### BACKGROUND

A text-to-speech engine is a software program that generates speech from inputted text. A text-to-speech engine may be useful in applications that use synthesized speech, such as a wireless communication device that reads incoming text messages, a global positioning system (GPS) that provides voice directional guidance, or other portable electronic devices that present information as audio speech.

Many text-to-speech engines use Hidden Markov Model (HMM) based text-to-speech synthesis. A HMM is a finite state machine that generates a sequence of discrete time observations. At each time unit, the HMM changes states at a Markov process in accordance with a state transition probability and then generates observation data in accordance with an output probability distribution of the current state. HMM-based speech synthesis may be parameterized in a source-filtered model and statistically trained. However, limited by the use of the source-filtered model, HMM-based text-to-speech generation may produce speech that exhibits an intrinsic hiss-buzzing from the voice encoding (vocoding). Thus, speech generated based on the use of HMMs may not sound natural.

### SUMMARY

Described herein are techniques that use an HMM trajectory tiling (HTT)-based approach to synthesize speech from text. The use of the HTT-based approach, as described herein, may enable a text-to-speech engine to generate synthesized speech that retains a high quality of the conventional HMM-based approach, but is more natural sounding than speech that is synthesized using conventional HMM-based speech synthesis.

The HTT-based approach may initially generate improved speech trajectory from a text input by refining the HMM parameters. Subsequently, the HTT-based approach may render more natural sounding speech by selecting the most appropriate waveform segments to approximate the improved speech trajectory.

In at least one embodiment, a set of HMMs and a set of waveform units may be obtained from a speech corpus. The set of HMMs may be further refined using minimum generation error (MGE) training to generate a refined set of HMMs. Subsequently, a speech parameter trajectory may be generated by applying the refined set of HMMs to an input text. A unit lattice of candidate waveform units may then be selected from a set of waveform units based at least on the speech parameter trajectory. A normalized cross-correlation (NCC)-based search on the unit lattice may be performed to obtain a minimal concatenation cost sequence of candidate waveform units, which are concatenated into a waveform sequence that is further synthesized into speech.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a block diagram that illustrates an example scheme 100 that implements the HMM trajectory tiling (HTT)-based approach on an example text-to-speech engine to synthesize speech from input text.

FIG. 2 is a block diagram that illustrates selected components of an example text-to-speech engine that implements HTT-based text-to-speech generation.

FIG. 3 is an example lattice of candidate waveform units that are generated using candidate selection on a set of waveform units in the speech corpus.

FIG. 4 illustrates waveform unit concatenation of an optimal waveform unit sequence to form a concatenated waveform sequence.

FIG. 5 is a flow diagram that illustrates an example process to obtain HMMs and waveform units for use in HTT-based text-to-speech synthesis

FIG. 6 is a flow diagram that illustrates an example process to perform speech synthesis using the example text-to-speech engine.

FIG. 7 is a block diagram that illustrates a representative computing device that implements HTT-based text-to-speech generation.

### DETAILED DESCRIPTION

The embodiments described herein pertain to the use of an HMM trajectory tiling (HTT)-based approach to generate synthesized speech that is natural sounding. The HTT-based approach may initially generate an improved speech feature parameter trajectory from a text input by refining HMM parameters. During the refinement, a criterion of minimum generation error (MGE) may be used to improve HMMs trained by a conventional maximum likelihood (ML) approach. Subsequently, the HTT-based approach may render more natural sounding speech by selecting the most appropriate waveform units to approximate the improved feature parameter trajectory. In other words, the improved feature parameter trajectory may be used to guide waveform unit selection during the generation of the synthesized speech.

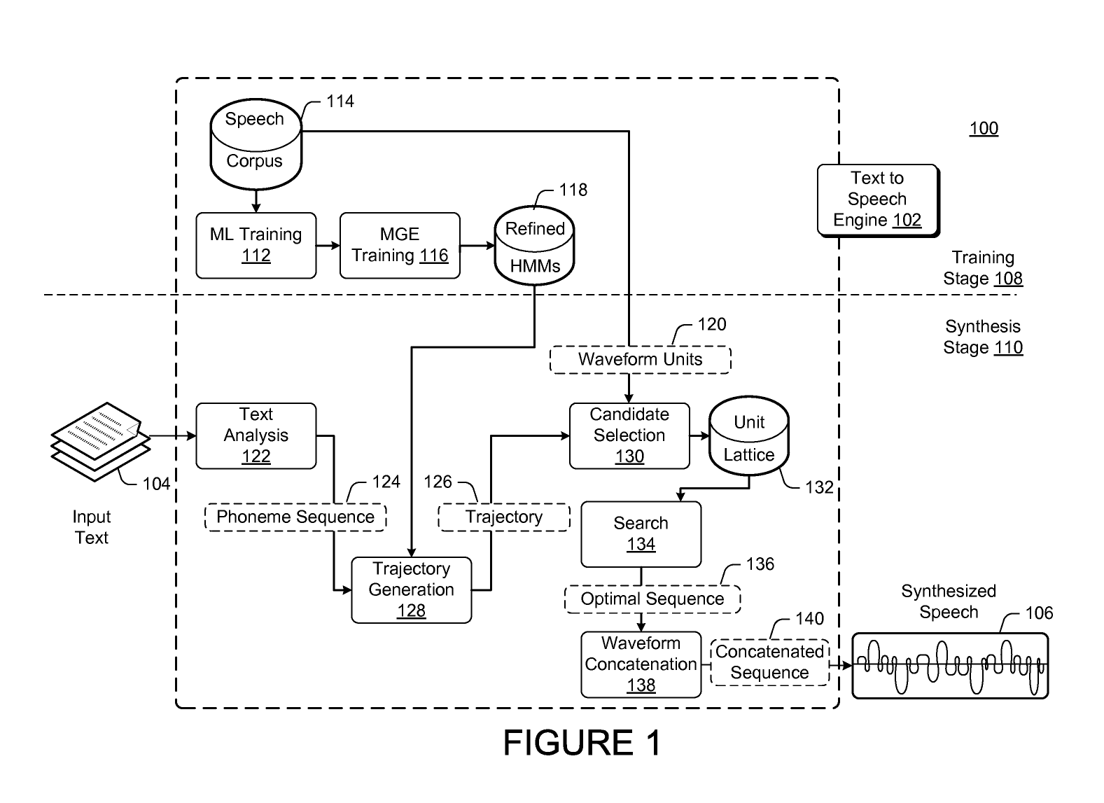

The implementation of the HTT-based approach to generate synthesized speech may provide synthesized speech that is more natural sounding. As a result, use of HTT-based speech synthesis may increase user satisfaction with embedded systems, server system, and other computing systems that present information via synthesized speech. Various example uses of the HTT-based approach to speech synthesis in accordance with the embodiments are described below with reference to FIGS. 1-7.

### Example Scheme

FIG. 1 is a block diagram that illustrates an example scheme 100 that implements the HTT-based approach on a text-to-speech engine 102 to synthesize speech from input text 104. Conversion of the input text 104 into the synthesized speech 106 by the text-to-speech engine 102 may involve a training stage 108 and a synthesis stage 110. During the training stage 108, the text-to-speech engine 102 may use maximum likelihood (ML) criterion training 112 to train a set of Hidden Markov Models (HMMs) based on a speech corpus 114 of sample speeches from a human speaker. For example, the speech corpus 114 may be a broadcast news style North American English speech when the ultimately desired synthesized speech 106 is to be North American-style English speech. In other examples, the speech corpus 114 may include sample speeches in other respective languages (e.g., Chinese, Japanese, French, etc.), depending on the desired language of the synthesized speech 106. The sample speeches in the speech corpus 114 may be stored as one or more files of speech waveforms, such as Waveform Audio File Format (WAVE) files.

The text-to-speech engine 102 may further refine the HMMs obtained from the speech corpus 114 using minimum generation error (MGE) training 116. During the MGE training 116, a criterion of minimum generation error (MGE) may be used to improve the HMMs to produce refined HMMs 118. The refined HMMs 118 that result from the training stage 108 are speech units that may be used to produce higher quality synthesized speech than HMMs that did not undergo the MGE training 116. The of refined HMMs 118 may differ from the speech waveforms in the speech corpus 114 in that the speech waveforms in the speech corpus 114 may carry static and dynamic parameters, while the refined HMMs 118 may only carry static parameters.

During the synthesis stage 110, the text-to-speech engine 102 may perform text analysis 122 on the input text 104. The input text 104 may be inputted into the text-to-speech engine 102 as electronic data (e.g., ACSCII data). During the text analysis 122, the text-to-speech engine 102 may convert the input text 104 into a phoneme sequence 124. The text-to-speech engine 102 may account for contextual or usage variations in the pronunciation of words in the input text 104 while performing the conversion. For example, the text “2010” may be read aloud by a human speaker as “two-thousand-ten” when it is used to refer to a number. However, when the text “2010” used to refer to a calendar year, it may be read as “twenty-ten.”

The text-to-speech engine 102 may convert the phoneme sequence 124 that results from the text analysis 122 into a speech parameter trajectory 126 via trajectory generation 128. In various embodiments, the sets of refined HMMs 118 from the training stage 108 may be applied to the phoneme sequence to generate the speech parameter trajectory 126.

At candidate selection 130, the text-to-speech engine 102 may use the speech parameter trajectory 128 to select waveform units from the set of waveform units 120 for a construction of a unit lattice 132 of candidate waveform units. Each waveform unit of the waveform units 120 is a temporal segment of a speech waveform that is stored in the speech corpus 114. For example, given a speech waveform in the form of a WAVE file that contains three seconds of speech, a waveform unit may be a 50 millisecond (ms) segment of those three seconds of speech. In some embodiments, the unit lattice 132 may be pruned to so that it becomes more compact in size. The text-to-speech engine 102 may then further perform a normalized cross-correlation (NCC) based search 134 on the unit lattice 132 to select an optimal sequence of waveform units 136, also known as “tiles”, along a best path through the unit lattice. Subsequently, the text-to-speech engine 102 may perform waveform concatenation 138 to concatenate the optimal sequence of waveform units (tiles) into a single concatenated waveform sequence 140. The text-to-speech engine 102 may then output the concatenated waveform sequence 140 as the synthesized speech 106.

### Example Components

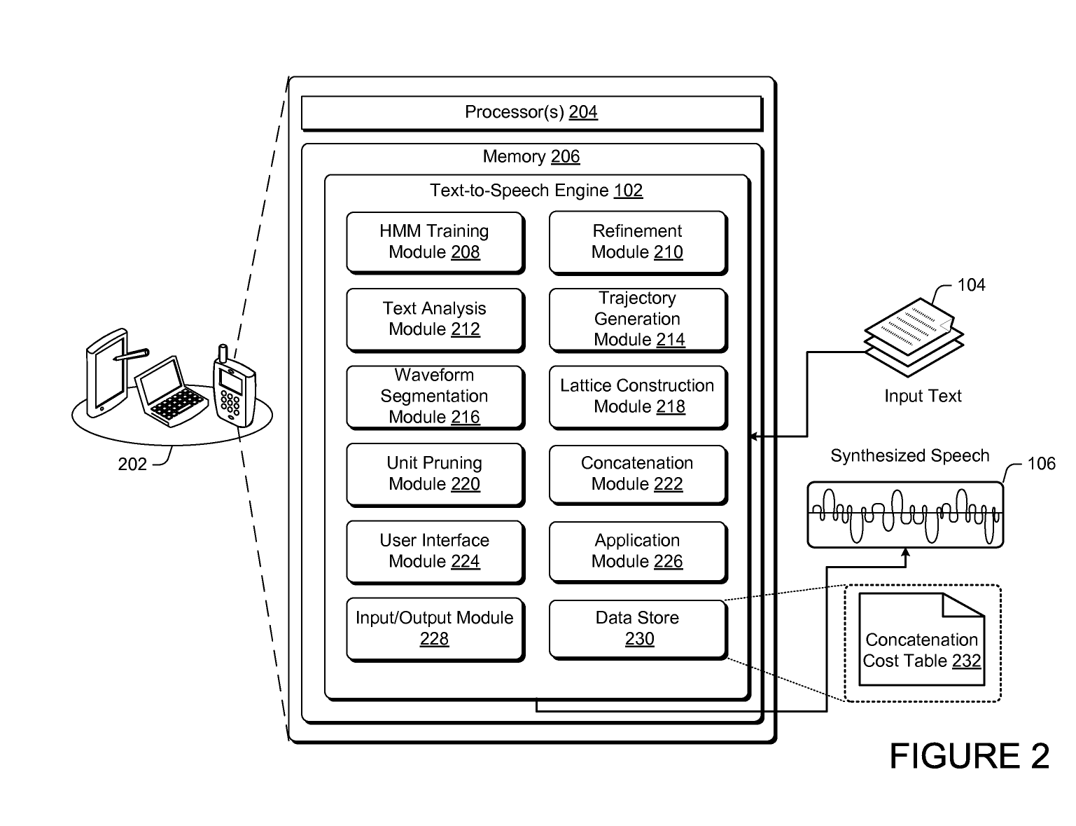

FIG. 2 is a block diagram that illustrates selected components of an example text-to-speech engine that implements the HTT-based approach. The example text-to-speech engine, such as the text-to-speech engine 102, may be implemented on various electronic devices 202. In various embodiments, the electronic devices 202 may include an embedded system, a smart phone, a personal digital assistant (PDA), a digital camera, a global position system (GPS) tracking unit, and so forth. However, in other embodiments, the electronic devices 202 may include a general purpose computer, such as a desktop computer, a laptop computer, a server, and so forth. Further, each of the electronic devices 202 may have network capabilities. For example, each of the electronic devices 202 may exchange data with other electronic devices (e.g., laptops computers, servers, etc.) via one or more networks, such as the Internet. In some embodiments, an electronic device 202 may be substituted with a plurality of networked servers, such as servers in a cloud computing network.

Each of the electronic devices 202 may include one or more processors 204 and memory 206 that implement components of the text-to-speech engine 102. The components, or modules, may include routines, programs instructions, objects, and/or data structures that perform particular tasks or implement particular abstract data types. The components may include a HMM training module 208, a refinement module 210, a text analysis module 212, a trajectory generation module 214, a waveform segmentation module 216, a lattice construction module 218, a unit pruning module 220, and a concatenation module 222. The components may further include a user interface module 224, an application module 226, an input/output module 228, and a data store 230. The components are discussed in turn below.

The HMM training module 208 may train a set of HMMs that are eventually used for speech synthesis. The speech features from the speech training data used for HMM training may include fundamental frequency (F₀), gain, and line spectrum pair (LSP) coefficients. Accordingly, during synthesis of speech from input text 104, the set of HMMs may be used to model spectral envelope, fundamental frequency, and phoneme duration.

The HMM training module 208 may train the set of HMMs using the speech corpus 114 that is stored in the data store 230. For example, the set of HMMs may be trained via a broadcast news style North American English speech sample corpus for the generation of American-accented English speech. In other examples, the set of HMMs may be similarly trained to generate speech in other languages (e.g., Chinese, Japanese, French, etc.).

The HMM training module 208 may use a maximum likelihood criterion (ML)-based approach to train the HMMs using the speech corpus 114. During training, the speech corpus 114 may be concatenated into a series of frames of a predetermined duration (e.g., 5 ms, one state, half-phone, one phone, diphone, etc.), so that HMMs may be trained based on such frames. In various embodiments, the ML-based training may be performed using a conventional expectation-maximization (EM) algorithm. Generally speaking, the EM algorithm may find maximum likelihood estimates of parameters in a statistical model, where the model depends on unobserved latent variables. The EM algorithm may iteratively alternate between performing an expectation (E) step, which computes the expectation of the log-likelihood evaluated using the current estimate for the latent variables, and maximization (M) step, which computes parameters maximizing the expected log-likelihood found on the E step. These parameter-estimates are then used to determine the distribution of the latent variables in the next E step. In some embodiments, the HMM training module 208 may further employ LSP coefficients as spectral features during the ML-based training. LSP coefficients may be well-suited for use as LSP coefficients generally possess good interpolation properties and correlate well with “formants”, i.e., spectral peaks that are often present in speech. The HMM training module 208 may store the set of trained HMMs in the data store 230.

The refinement module 210 may optimize the set of HMMs trained by the HMM training module 208 by further implementing minimum generation error (MGE) training. The MGE training may adjust the set of trained HMMs to minimize distortions in speeches that are synthesized using the set of trained HMMs. For example, given known acoustic features of a training speech corpus, the MGE training may modify the set of HMMs so that acoustic features generated from the set of HMMs may be as similar as possible to known acoustic features. In various embodiments, Euclidean distance or log spectral distortion (LSD) may be used during the MGE training to measure the distortion between the acoustic features. With the use of such tools, the refinement module 210 may refine the alignment of the set of HMMs and the LSP coefficients. The refinement module 210 may store the refined HMMs 118 in the data store 230.

The text analysis module 212 may process input text, such as the input text 104, into phoneme sequences, such as the phoneme sequence 124. Each of the phoneme sequences may then be further feed into the trajectory generation module 214. The text analysis module 212 may perform text analysis to select a pronunciation of the words (or string or words) in an input text 104 based on context and/or normal usage. For example, the text “2010” may be read aloud by a speaker as “two-thousand-ten” when it is used to refer to a number. However, when the text “2010” used to refer to a calendar year, it may be read as “twenty-ten.” Thus, in order to account for such contextual and usage variability, the text analysis module 212 may use several different techniques to analyze and parse the input text 104 into a corresponding phoneme sequence. The techniques may include one or more of text normalization, sentence segmentation, tokenization, normalization of non-standard words, statistic part-of-speech tagging, statistic syllabification, word stress assignment, and/or grapheme-to-phoneme conversion.

The text analysis module 212 may use sentence segmentation to split the input text 104 into sentences by detecting sentence boundaries (e.g., periods). Tokenization may be used to split text into words at white spaces and punctuation marks. Further, the text analysis module 212 may use normalization of non-standard words to expand non-standard words into appropriate orthographic form. For example, normalization may expand the text “2010” into either “two-thousand-ten” or “twenty-ten” based on the usage context by using heuristic rules, language modeling, or machine learning approaches. The text analysis module 212 may also use statistical part-of-speech tagging to assign words into different parts of speech. In some instances, such assignment may be performed using rule-based approaches that operate on dictionaries and context-sensitive rules. Statistic part-of-speech tagging may also rely on specialized dictionaries of out-of-vocabulary (OOV) words to deal with uncommon or new words (e.g., names of people, technical terms, etc.).

The text analysis module 212 may use word stress assignment to impart the correct stress to the words to produce natural sounding pronunciation of the words. The assignment of stress to words may be based on phonological, morphological, and/or word class features of the words. For example, heavy syllables attract more stress than weak syllables. Additionally, the text analysis module 212 may use grapheme-to-phoneme conversion to convert the graphemes that are in the words to corresponding phonemes. Once again, specialized OOV dictionaries may be used during grapheme-to-phoneme conversion to deal with uncommon or new words. In other embodiments, the text analysis module 212 may also use additional and/or alternative techniques to account for contextual or usage variability during the conversion of inputs texts into corresponding phoneme sequences.

The trajectory generation module 214 may generate speech parameter trajectories for the phoneme sequences, such as the phoneme sequence 124 that is obtained from the input text 104. In various embodiments, the trajectory generation module 214 may generate a speech parameter trajectory 126 by applying the trained and refined set of HMMs 118 to the phoneme sequence 124. The generated speech parameter trajectory 126 may be a multi-dimensional trajectory that encapsulates fundamental frequency (F₀), spectral envelope, and duration information of the phoneme sequence 124.

In some embodiments, the trajectory generation module 214 may further compensate for voice quality degradation caused by noisy or flawed acoustic features in the original speech corpus 114 that is used to develop the HMMs. The compensation may be performed with the application of a minimum voiced/unvoiced (v/u) error algorithm. These flaws in the training data may cause fundamental frequency (F₀) tracking errors and corresponding erroneous voiced/unvoiced decisions during generation of a speech parameter trajectory. In order to apply the minimum v/u algorithm to a phoneme sequence, such as the phoneme sequence 124, the trajectory generation module 214 may employ the knowledge of the v/u labels for each phone in the sequence. The phones may be labeled as voiced (v) or unvoiced (u) based on the manner of vocal fold vibration of each phone. Thus, the knowledge of the v/u label for each phone may be incorporated into v/u prediction and the accumulated v/u probabilities may be used to search for the optimal v/u switching point.

During operation, two kinds of state sequences may be defined for any two successive segments in a phoneme sequence: (1) an UV sequence, which has only one unvoiced to voiced switching point and includes all preceding u states and succeeding v states; and (2) a VU sequence, similar to UV sequence but in which v states precede u states. Each state may inherit its state from its parent phone.

Accordingly, the accumulated v/u errors, eⱼ^{uv}, j=1, . . . , N, and eⱼ^{vu}, j=1, . . . , M for UV and VU state sequences may be defined in equations (1) and (2) as follows:

eⱼ^{uv}=Vⱼ^{uv}+Uⱼ^{uv} (1)

Vⱼ^{uv}=Vⱼ₋₁^{uv}+γ(j,g,=v), V₀^{uv}=0, j=1, . . . ,N

Uⱼ^{uv}=Vⱼ₊₁^{uv}+γ(j,g,=v), V_{N+1}^{uv}=0, j=1, . . . ,N

eⱼ^{uv}=Vⱼ^{uv}+Uⱼ^{vu} (2)

Vⱼ^{vu}=Vⱼ₋₁^{vu}+γ(j,g,=v), V_{M+1}^{vu}=0, j=M, . . . ,1

Uⱼ^{vu}=Vⱼ₊₁^{vu}+γ(j,g,=v), V₀^{vu}=0, j=1, . . . ,M

in which γ(j, g=v) and γ(j, g=u) are the accumulated posterior probabilities summing over all frames in state j and in a voiced subspace (g=v) or an unvoiced subspace (g=u), i.e., γ(j, g)=Σₜγₜ(j, g). Further, only one V/U switching point is allowed and the V/U switching point is set at the minimum eⱼ^{uv} and eⱼ^{vu} for each UN or V/U state sequence.

As such, for a UV state sequence, i=min(eⱼ^{uv}), i.e., all states preceding i are all unvoiced, and those succeed i are voiced, and the V/U ratio for the state i and subspace g, the voice subspace probability w_{j,g} may be calculated in equation (3) as:

$${w}_{j , g} = \frac{{\sum }_{t , g ∈ s ( {o}_{t} )} {γ}_{t} ( j , g )}{{\sum }_{g} {\sum }_{t , g ∈ s ( {o}_{t} )} {γ}_{t} ( j , g )} \qquad ( 3 )$$

in which γₜ(j, g) is the posterior probability of an observation in state j and subspace g at time t, which may be estimated by a Forward-Backward algorithm. Likewise, the v/u decision for VU state sequence may be similarly implemented as for the UV state sequence above, but with searching for the optimal voiced to unvoiced switching point instead. Thus, by using the minimum u/v error algorithm, the trajectory generation module 214 may reduce v/u prediction errors in fundamental frequency (F₀) generation to ultimately produce more pleasant sounding synthesized speech.

In additional embodiments, the trajectory generation module 214 may further refine the generated speech parameter trajectories to improve the quality of the eventual synthesized speeches. The trajectory generation module 214 may use formant sharpening to reduce over-smoothing generally associated with speech parameter trajectories that are generated using HMMs. Over-smoothing of a speech parameter trajectory, such as the speech parameter trajectory 126, may result in synthesized speech that is unnaturally dull and distorted. Formant sharpening may heighten the formants (spectral peaks) that are encapsulated in a speech parameter trajectory, so that the resultant speech parameter trajectory more naturally mimics the clarity of spoken speech.

The waveform segmentation module 216 may generate waveform units 120 from the speech waveforms of the speech corpus 114. In various embodiments, the waveform segmentation module 216 may be capable of segmenting a single speech waveform into multiple sets of waveform units of varied time lengths. As further described below, the time lengths of the waveform units generated by the waveform segmentation module 216 may affect both the ease of the eventual speech generation and the quality of the synthesized speech that is generated.

As such, the waveform segmentation module 216 may generate set of waveform units 120 in which each unit is 5 ms in duration, one state in duration, half-phone in duration, one phone in duration, diphone in duration, or of another duration. Further, the waveform segmentation module 216 may generate a set of waveform units 120 having waveform units of a particular time length based on the overall size of the speech corpus 114.

For example, when the corpus of speech is approximately one hour in size, the waveform segmentation module 216 may generate a set of waveform units in which each unit is 5 ms or one state in time length. When the speech corpus 114 is approximately four to six hours in size, the waveform segmentation module 216 may generate a set of waveform units in which each unit is one state or half-phone in time length. Further, when the speech corpus 114 is approximately four to six hours in size, the waveform segmentation module 216 may generate a set of waveform units in which each unit is one phone or one diphone in time length.

The lattice construction module 218 may generate a unit lattice for each speech parameter trajectory produced by the trajectory generation module 214. For example, the lattice construction module 218 may perform candidate selection on the set of waveform units 120 using the corresponding speech parameter trajectory 126 to generate the unit lattice 132. In some embodiments, the corresponding speech parameter trajectory 126 may be a formant sharpened speech parameter trajectory.

In various embodiments, normalized distances between the speech parameter trajectory 126 and the set of waveform units 120 may be used to select potential waveform units for the construction of the unit lattice. Recall that the speech features used by the HMM training module 208 to train the HMMs that produced the speech parameter trajectory 126 are LSP coefficients, gain and fundamental frequency (Fₒ). Accordingly, the distances of these three features per each frame may be defined in equations (4), (5), (6), and (7) by:

d_{F0}=|log(F0ₜ)−log(F0_{c})| (4)

d_{G}=|log(Gₜ)−log(G_{c})| (5)

$$\begin{matrix}{d}_{ω} = \sqrt{\frac{1}{I} {\sum }_{i = 1}^{I} {{w}_{i} ( {ω}_{t , i} - {ω}_{c , i} )}^{2}} & ( 6 ) \\ {w}_{i} = \frac{1}{{ω}_{t , i} - {ω}_{t , i - 1}} + \frac{1}{{ω}_{t , i + 1} - {ω}_{t , i}} & ( 7 )\end{matrix}$$

in which the absolute value of F₀ and gain difference in log domain between target frame F₀ₜ, Gₜ and candidate frame F_{0c}, G_{c} are computed, respectively. It is an intrinsic property of LSP coefficients that clustering of two or more LSP coefficients creates a local spectral peak and the proximity of clustered LSP coefficients determines its bandwidth. Therefore, the distance between adjacent LSP coefficients may be more critical than the absolute value of individual LSP coefficients. The inverse harmonic mean weighting (IHMW) function may be used for vector quantization in speech coding or directly applied to spectral parameter modeling and generation. The lattice construction module 218 may compute the distortion of LSP coefficients by a weighted root mean square (RMS) between I-th order LSP vectors of the target frame ωₜ=[ω_{t,1}, . . . , ω_{tI}] cod and a candidate frame ω_{c}[ω_{c,1}, . . . , ω_{c,I}], as defined in equation (6), where wᵢ is the weight for i-th order LSP coefficients and defined in equation (7). In some embodiments, the lattice construction module 218 may only use the first I LSP coefficients out of the N-dimensional LSP coefficients since perceptually sensitive spectral information is located mainly in the low frequency range below 4 kHz.

The distance between a target unit uₜ of the speech parameter trajectory 126 and a candidate unit u_{c} (i.e., waveform unit) in the set of waveform units 120 maybe defined in equation (8), where d̅ is the mean distance of constituting frames. In the embodiments, the time lengths of the target units used by the lattice construction module 218 may be the same as the time lengths of the waveform units generated from the speech corpus. Generally, different weights may be assigned to different feature distances due to their dynamic range difference. To avoid the weight tuning, the lattice construction module 218 may normalize the distances of all features to a standard normal distribution with zero mean and a variance of one. Accordingly, the resultant normalized distance may be shown in equation (8) as follows:

d(uₜ,u_{c})=N( d̅_{F0})+N( d̅_{G})+N( d̅_{ω}) (8)

Thus, by applying the equations (4)-(8) described above, the lattice construction module 218 may construct a unit lattice, such as the unit lattice 132, of waveform units. As further described below, the waveform units in the unit lattice 132 may be further searched and concatenated to generate synthesized speech 106.

In some embodiments, rather than using a formant-sharpened speech parameter trajectory 126 for distance comparison to the set of waveform units 120, the lattice construction module 218 may dull, that is, smooth the spectral peaks captured by the waveform units 120 prior to implementing the distance comparison. The dulling of the waveform units 120 may compensate for the fact that the set of waveform units 120 naturally encapsulate shaper formant structure and richer acoustic detail than the HMMs that are used to produce a speech parameter trajectory. In this way, the accuracy of the distance comparison for the construction of the unit lattice may be improved.

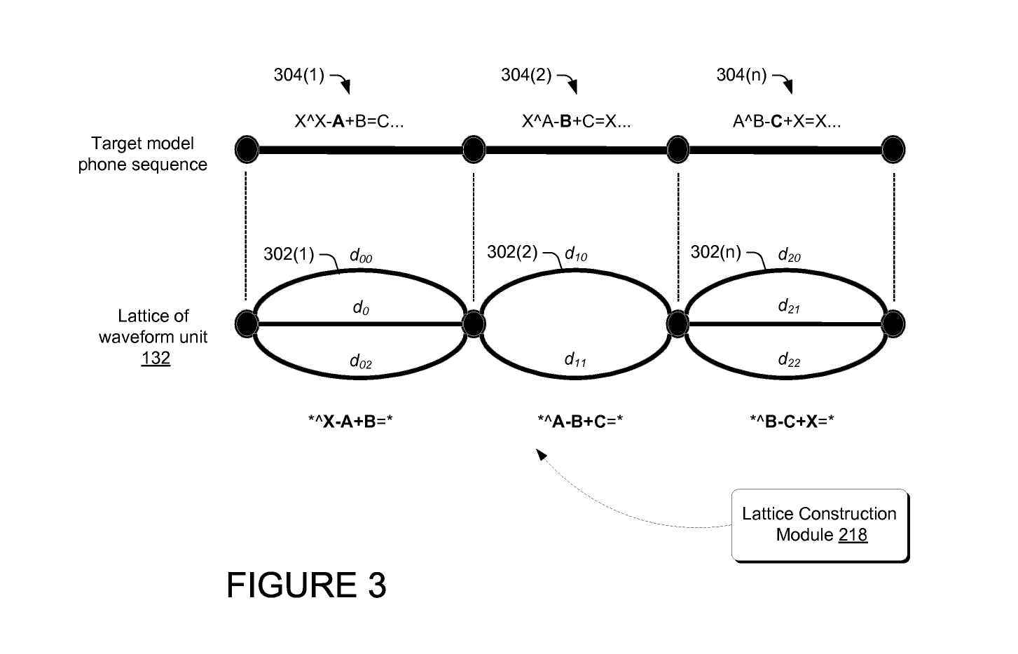

FIG. 3 is an example unit lattice, such as the unit lattice 132, in accordance with various embodiments. The unit lattice 132 may be generated by the lattice construction module 218 for the input text 104. Each of the nodes 302(1)-302(n) of the unit lattice 132 may correspond to context factors of target unit labels 304(1)-304(n), respectively. As shown in FIG. 3, some contextual factors of each target unit labels 304(1)-304(n) are replaced by “ . . . ” for the sake of simplicity, and “*” may represent wildcard matching of all possible contextual factors.

Returning to FIG. 2, the unit pruning module 220 may prune a unit lattice, such as unit lattice 132 of waveform units that is generated by the lattice construction module 218. In various embodiments, the unit pruning module 220 may implement one or more pruning techniques to reduce the size of the unit lattice. These pruning techniques may include context pruning, beam pruning, histogram pruning techniques, and/or the like. Context pruning allows only unit hypotheses with a same label as a target unit to remain in the unit lattice. Thus, context pruning may reduce the workload of the concatenation module 222 by removing redundant waveform units from the set of waveform units in the unit lattice. Beam pruning retains only unit hypotheses within a preset distance to the best unit hypothesis. Histogram pruning limits the number of surviving unit hypotheses to a maximum number.

The reduction of the size of the unit lattice may ensure that the subsequent search and concatenation for the generation of synthesized speech may be performed in a reasonable amount of time (e.g., no more than 4-5 seconds). Thus, in some embodiments, the unit pruning module 220 may have the ability to assess the number and processing speed of the processors 204, and implement a reduced number of pruning techniques or no pruning on the unit lattice when processing power is more abundant. Conversely, when the processing power is less abundant, the unit pruning module 220 may implement an increased number of pruning techniques.

The concatenation module 222 may search for an optimal waveform unit path through the waveform units in the unit lattice 302 that have survived pruning. In this way, the concatenation module 222 may derive the optimal waveform unit sequence 136. The optimal waveform unit sequence 136 may be the smoothest waveform unit sequence. In various embodiments, the concatenation module 222 may implement the search as a search for a path with minimal concatenation cost. Accordingly, the optimal sequence of waveform units 136 may be a minimal concatenation cost sequence. The concatenation module 222 may further concatenate the optimal waveform unit sequence 136 to form a concatenated waveform sequence 138. Subsequently, the concatenated waveform sequence 138 may be converted into synthesize speech.

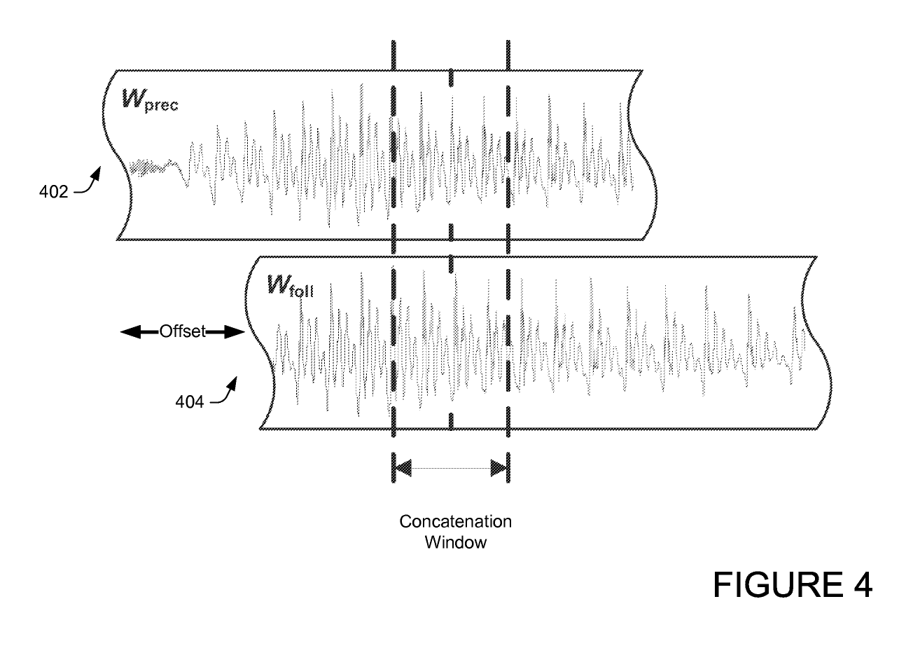

In various embodiments, the concatenation module 222 may use a normalized cross correlation as the measure of concatenation smoothness. Given two time series x(t), y(t), and an offset of d, the concatenation module 222 may calculate the normalized cross correlation r(d) in equation (9) as follows:

$$r ( d ) = \frac{{\sum }_{t} [ ( x ( t ) ) - {μ}_{x} \cdot ( y ( t - d ) - {μ}_{y} ) ]}{\sqrt{{\sum }_{t} {[ x ( t ) - {μ}_{x} ]}^{2}} \cdot \sqrt{{\sum }_{t} {[ y ( t - d ) - {μ}_{y} ]}^{2}}} \qquad ( 9 )$$

in which μₓ and μ_{y} are the mean of x(t) and y(t) within the calculating window, respectively. Thus, at each concatenation point in the lattice 302, and for each waveform pair, the concatenation module 222 may first calculate the best offset d that yields the maximal possible r(d), as illustrated in FIG. 4.

FIG. 4 illustrates waveform unit concatenation of an optimal waveform unit sequence, such as the optimal waveform unit sequence 136, to form a concatenated waveform sequence, such as the concatenates waveform sequence 138. As shown, for a preceding waveform unit W_{prec} 402 and the following unit W_{foll} 404, the concatenation module 222 may fix a concatenation window of length L at the end of the W_{prec} 402. Further, the concatenation module 222 may set the range of the offset d to be [−L/2, L/2], so that a following waveform W_{foll} 404 may be allowed to shift within that range to obtain the maximal d(r). In at least some embodiments of waveform concatenation, the following waveform unit W_{foll} 404 may be shifted according to an offset r that yields an optimal d(r). Further, a triangle fade-in/fade-out window may be applied on the preceding waveform unit W_{prec} 402 and the following waveform unit W_{foll} 404 to perform cross fade-based waveform concatenation. Finally, the waveform sequence that has the maximal, accumulated d(r) may be chosen as the optimal path.

Returning to FIG. 2, it will be appreciated that the calculation of the normalized cross-correlation in equation (9) may introduce a lot of input/output (I/O) and computation efforts if the waveform units are loaded during run-time of the speech synthesis. Thus, in some embodiments, the concatenation module 222 may calculate the normalized cross-correlation in advance, such as during an off-line training phase, to build a concatenation cost table 232. Thus, the concatenation cost table 232 may be further used during waveform concatenation along the path of the selected optimal waveform unit sequence.

The concatenation module 222 may use waveform unit hypotheses that are the same time lengths as the target units that were used during the construction of the unit lattice 132 for concatenation. Moreover, when the concatenation module 222 is able to use longer length waveform units 120, a concatenated waveform sequence 138 may be generated by the concatenation module 222 with fewer concatenation points. The generation of the concatenated waveform sequence 138 with the use of fewer concatenation points may result in high quality synthesized speech 106. In other words, since the concatenated waveform sequence 138 is produced by concatenating waveform units together at the concatenation points, the less the concatenation points, the more natural sound the synthesized speech. Thus, the concatenation module 222 may use a unit lattice 132 with waveform units having the longest time lengths, as generated by the lattice construction module 218. As described above, the time lengths of the waveform units may be based on the size of the speech corpus 114 (e.g., the bigger the speech corpus 114, the longer the lengths of the waveform units).

However, when one or more waveform units in the unit lattice 132 are too long in time length (e.g., exceed a threshold length), no matching waveform unit hypotheses may be found in the unit lattice 132 during the NCC-based search to produce the optimal waveform unit sequence 136. In such an instance, the concatenation module 222 may cause the lattice construction module 218 to construct another unit lattice 132 using target units in the speech parameter and corresponding waveform units 120 that are shorter in time length. Subsequently, when the unit lattice 132 is pruned, the concatenation module 222 may once again attempt to find the optimal waveform unit sequence 136.

Thus, the concatenation module 222 may perform such back off and reattempts using one or more unit lattices 132 that includes waveform units that are progressively shorter in time length until the optimal waveform unit sequence 136 is found, or a predetermined number of retries are attempted. Such flexible back off and retry attempts may enable the text-to-speech engine 102 to generate a concatenated waveform sequence 138 that is produced using the least number of concatenation points. Subsequent to the generation of the concatenated waveform sequence 138, the text-to-speech engine 102 may further process the concatenated waveform sequence 138 into synthesized speech 106.

The user interface module 224 may enable a user to interact with the user interface (not shown) of an electronic device 202. The user interface may include a data output device (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods. The user interface module 224 may enable a user to input or select the input text 104 for conversion into synthesized speech 106.

The application module 226 may include one or more applications that utilize the text-to-speech engine 102. For example, but not as a limitation, the one or more applications may include a global positioning system (GPS) navigation application, a dictionary application, a text messaging application, a word processing application, and the like. Accordingly, in various embodiments, the text-to-speech engine 102 may include one or more interfaces, such as one or more application program interfaces (APIs), which enable the application module 226 to provide input text 104 to the text-to-speech engine 102.

The input/output module 228 may enable the text-to-speech engine 102 to receive input text 104 from another device. For example, the text-to-speech engine 102 may receive input text 104 from at least one of another electronic device, (e.g., a server) via one or more networks. Moreover, the input/output module 228 may provide the synthesized speech 106 to the audio speakers for acoustic output, or to the data store 230.

As described above, the data store 230 may store the HMMs, such as the unrefined HMMs and refined HMMs 118. The data store 230 may also store waveform units, such as waveform units 120. The data store 230 may further store input texts, phoneme sequences, speech parameter trajectories, unit lattices, optimal waveform unit sequences, concatenated waveform sequences, and synthesized speech. The input text may be in various forms, such as documents in various formats, downloaded web pages, and the like. The synthesized speech may be stored in any audio format, such as .wav, mp3, etc. The data store 230 may also store any additional data used by the text-to-speech engine 102, such as various additional intermediate data produced during the generation of synthesized speech (e.g., synthesized speech 106) from a corresponding input text (e.g., input t text 104).

### Example Processes

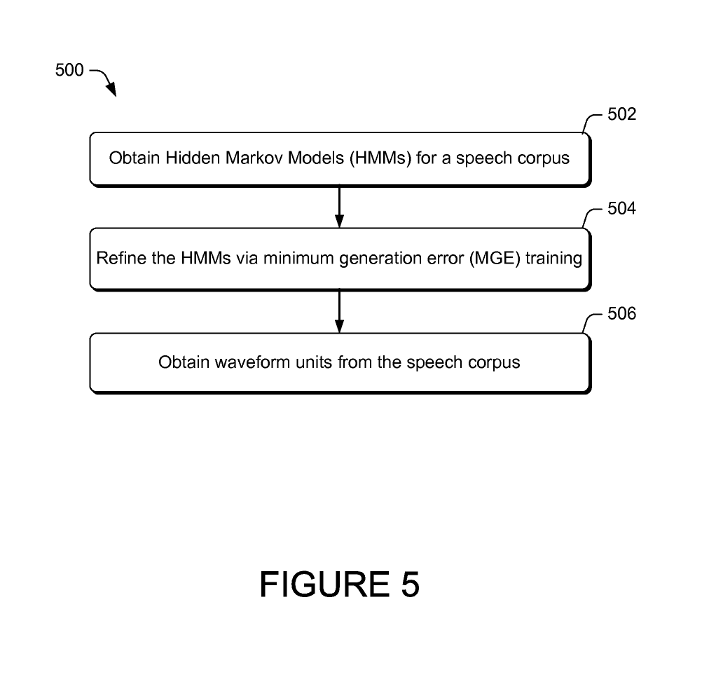

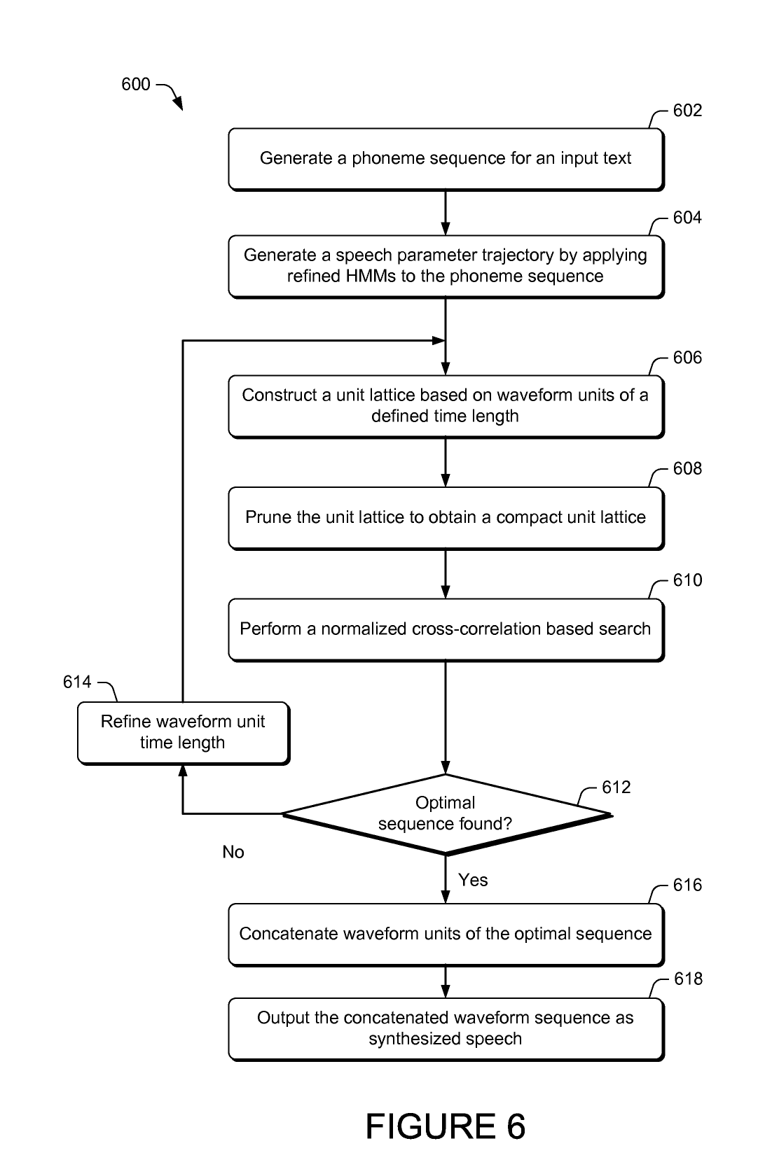

FIGS. 5-6 describe various example processes for implementing the HTT-based approach for text-to-speech synthesis. The order in which the operations are described in each example process is not intended to be construed as a limitation, and any number of the described blocks can be combined in any order and/or in parallel to implement each process. Moreover, the blocks in the FIGS. 5-6 may be operations that can be implemented in hardware, software, and a combination thereof. In the context of software, the blocks represent computer-executable instructions that, when executed by one or more processors, cause one or more processors to perform the recited operations. Generally, computer-executable instructions include routines, programs, objects, components, data structures, and the like that cause the particular functions to be performed or particular abstract data types to be implemented.

FIG. 5 is a flow diagram that illustrates an example process 500 to obtain HMMs and waveform units for use in the HTT-based text-to-speech synthesis. At 502, the HMM training module 208 may obtain a set of Hidden Markov Models (HMMs) from a speech corpus 114. In various embodiments, the HMM training module 208 may use a maximum likelihood criterion (ML)-based approach to train the set of HMMs. The ML-based training may be performed using a conventional expectation-maximization (EM) algorithm. Moreover, the HMM training module 208 may further employ LSP coefficients as spectral features during the ML-based training.

At 504, the refinement module 210 may further refine the set of HMMs obtained from the speech corpus 114 via minimum generation error (MGE) training 116. For example, given known acoustic features of a training speech corpus, the MGE training may modify the set of HMMs so that acoustic features generated from the set HMMs may be as similar as possible to the known acoustic features.

At 506, the waveform segmentation module 216 may obtain a set of waveform units from the speech waveforms of the speech corpus 114. In some embodiments, the waveform segmentation module 216 may be capable of segmenting a single speech waveform into multiple sets of waveform units of varied time lengths. The time length of the waveform units that are generated may be defined based on the size of the speech corpus 114.

FIG. 6 is a flow diagram that illustrates an example process 600 to perform a speech synthesis using the HTT-based text-to-speech engine. At 602, the text analysis module 212 may generate a phoneme sequence 124 for an input text 104. In various embodiments, the text analysis module 212 may perform contextual and/or usage normalization analysis during the generation of the phoneme sequence 124.

At 604, the trajectory generation module 214 may generate a speech parameter trajectory 126 by applying the refined HMMs 118 to the phoneme sequence 124. In some embodiments, the trajectory generation module 214 may further use formant sharpening to refine the speech parameter trajectory 126. Alternatively or concurrently, the trajectory generation module 214 may also apply a minimum voiced/unvoiced (v/u) error algorithm to the speech parameter trajectory 126 to compensate for voice quality degrades caused by noisy or flawed acoustic features in the original speech corpus 114.

At 606, the lattice construction module 218 may construct a unit lattice 132 by using normalized distances between target units in the speech parameter trajectory 126 and the set of waveform units 120 to select specific candidate waveform units. In some embodiments, the time length of each target unit may be defined according to the time length of each corresponding waveform unit 120. As described above, the time length of the waveform units may be defined based on the size of the speech corpus 114.

At 608, the unit pruning module 220 may prune the unit lattice 132 into a smaller size. In various embodiments, one or more of a context pruning technique, beam pruning technique, or histogram pruning technique may be used by the unit pruning module 220.

At 610, the concatenation module 222 may perform a normalized cross-correlation (NCC)-based search on the pruned unit lattice 132 to find an optimal sequence of waveform units 136. In other words, the concatenation module 222 may implement a search for a path through the waveform units of the unit lattice 132 that has minimal concatenation cost.

At decision 612, the concatenation module 222 may determine whether the optimal sequence of waveform units 136 is found. In some instances, when one or more waveform units (tiles) 120 in the unit lattice 132 are too long in time length, no matching waveform unit hypotheses may be found in the unit lattice 132 during the NCC-based search. Thus, if the concatenation module 222 determines that no optimal sequence of waveform units 136 is found (“no” at decision at 612), the process 600 may proceed to 614. At 614, the concatenation module 222 may refine the time length of the waveform units in the unit lattice 132. In various embodiments, the refinement may include decreasing the time length of the waveform units that are incorporate into a second version of the unit lattice 132.

However, if the concatenation module 222 determines that the optimal sequence of waveform units 136 is found (“yes” at decision 612), the concatenation module 222 may concatenate the waveform units into the concatenated waveform sequence 140 at 616. Subsequently, at 618, the concatenated waveform sequence 140 may be outputted as the synthesized speech 106. The synthesized speech 106 may be outputted to an acoustic speaker and/or the data store 230.

In some embodiments, the refinement at 614 may be reattempted for a predetermined number of times (e.g., five times) when no optimal sequence of waveform units 136 is found via successive refinements, at which point the process 600 may abort with an audible or visual error message that is presented to a user. The error message may indicate to the user that the speech synthesis was not successful.

### Example Computing Device

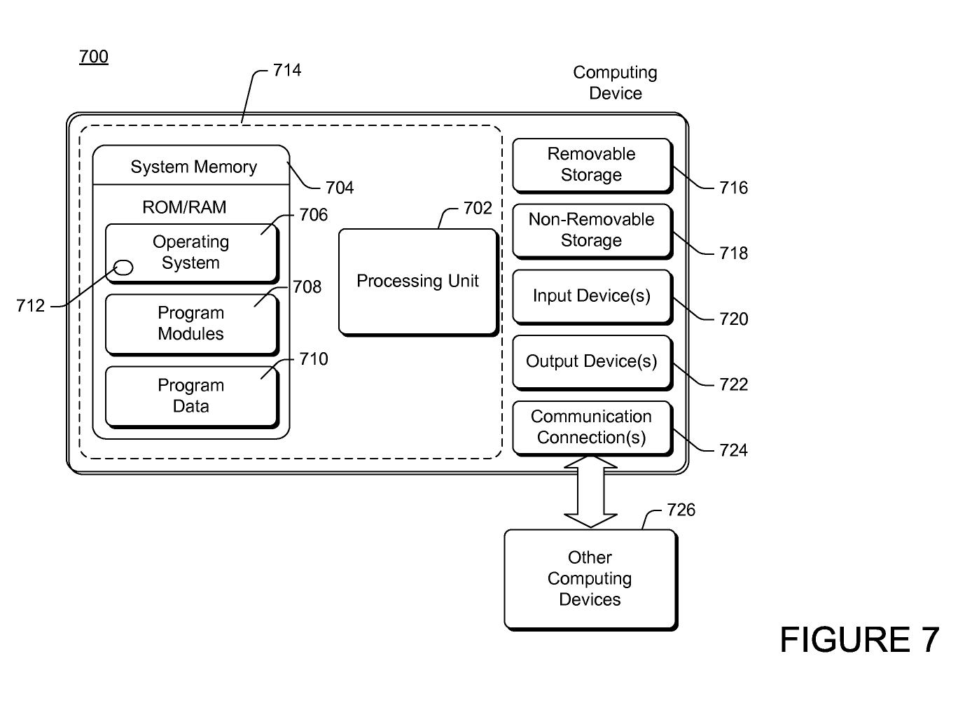

FIG. 7 illustrates a representative computing device 700 that may be used to implement the text-to-speech engine 102 that uses a HTT-based approach for speech synthesis. However, it is understood that the techniques and mechanisms described herein may be implemented in other computing devices, systems, and environments. The computing device 700 shown in FIG. 7 is only one example of a computing device and is not intended to suggest any limitation as to the scope of use or functionality of the computer and network architectures. Neither should the computing device 700 be interpreted as having any dependency or requirement relating to any one or combination of components illustrated in the example computing device.

In at least one configuration, computing device 700 typically includes at least one processing unit 702 and system memory 704. Depending on the exact configuration and type of computing device, system memory 704 may be volatile (such as RAM), non-volatile (such as ROM, flash memory, etc.) or some combination thereof. System memory 704 may include an operating system 706, one or more program modules 708, and may include program data 710. The operating system 706 includes a component-based framework 712 that supports components (including properties and events), objects, inheritance, polymorphism, reflection, and provides an object-oriented component-based application programming interface (API). The computing device 700 is of a very basic configuration demarcated by a dashed line 714. Again, a terminal may have fewer components but may interact with a computing device that may have such a basic configuration.

Computing device 700 may have additional features or functionality. For example, computing device 700 may also include additional data storage devices (removable and/or non-removable) such as, for example, magnetic disks, optical disks, or tape. Such additional storage is illustrated in FIG. 7 by removable storage 716 and non-removable storage 718. Computer storage media may include volatile and nonvolatile, removable and non-removable media implemented in any method or technology for storage of information, such as computer-readable instructions, data structures, program modules, or other data. System memory 704, removable storage 716 and non-removable storage 718 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by Computing device 700. Any such computer storage media may be part of device 700. Computing device 700 may also have input device(s) 720 such as keyboard, mouse, pen, voice input device, touch input device, etc. Output device(s) 722 such as a display, speakers, printer, etc. may also be included.

Computing device 700 may also contain communication connections 724 that allow the device to communicate with other computing devices 726, such as over a network. These networks may include wired networks as well as wireless networks. Communication connections 724 are some examples of communication media. Communication media may typically be embodied by computer-readable instructions, data structures, program modules, etc.

It is appreciated that the illustrated computing device 700 is only one example of a suitable device and is not intended to suggest any limitation as to the scope of use or functionality of the various embodiments described. Other well-known computing devices, systems, environments and/or configurations that may be suitable for use with the embodiments include, but are not limited to personal computers, server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like.

The implementation of the HTT-based approach to generate synthesized speech may provide synthesized speeches that are more natural sounding. As a result, user satisfaction of synthesized speech may increase when users interact with embedded systems, server system, and other computing systems that present information via synthesized speech.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as exemplary forms of implementing the claimed subject matter.

1. A computer-readable medium storing computer-executable instructions that, when executed, cause one or more processors to perform acts comprising:
obtaining a set of Hidden Markov Models (HMMs) and a set of waveform units from a speech corpus;
refining the set of HMMs via minimum generation error (MGE) training to generate a refined set of HMMs;
generating a speech parameter trajectory by applying the refined set of HMMs to an input text;
constructing a unit lattice of candidate waveform units selected from the set of waveform units based at least on the speech parameter trajectory;
performing a normalized cross-correlation (NCC)-based search on the unit lattice to obtain a minimal concatenation cost sequence of candidate waveform units; and
concatenating the minimum concatenation cost sequence of candidate waveform units into a concatenated waveform sequence.

2. The computer-readable medium of claim 1, further comprising storing an instruction that, when executed, cause the one or more processors to perform an act of outputting the concatenated waveform sequence as synthesized speech.

3. The computer-readable medium of claim 2, wherein the outputting includes outputting the synthesized speech to at least one of an acoustic speaker or a data storage.

4. The computer-readable medium of claim 1, further comprising instructions that, when executed, cause the one or more processors to perform an act of converting the input text into an phoneme sequence based at least in part on context or usage information of the input text.

5. The computer-readable medium of claim 1, further comprising instructions that, when executed, cause the one or more processors to perform an act of formant sharpening on the speech parameter trajectory to reduce over-smoothing of the speech parameter trajectory.

6. The computer-readable medium of claim 1, further comprising instructions that, when executed, cause the one or more processors to perform an act of applying a minimum voiced/unvoiced error algorithm to the speech parameter trajectory to compensate for voice quality degrades caused by noisy or flawed acoustic features in the speech corpus.

7. The computer-readable medium of claim 1, further comprising instructions that, when executed, cause the one or more processors to perform an act of pruning the unit lattice using at least one of context pruning, beam pruning, or histogram pruning.

8. The computer-readable medium of claim 1, wherein the speech parameter trajectory includes target units, and wherein the constructing the unit lattice includes using normalized distances between the target units and the set of waveform units to select the candidate waveform units, each of the distances measuring differences between line spectral pair (LSP) coefficients, gains, and fundamental frequencies of a target unit and a waveform unit.

9. The computer-readable medium of claim 8, further comprising instructions that, when executed, cause the one or more processors to perform an act of smoothing spectral peaks of the speech parameter trajectory prior to the constructing of the unit lattice.

10. A computer implemented method, comprising:
under control of one or more computing systems configured with executable instructions,
obtaining a set of Hidden Markov Models (HMMs) and an initial set of waveform units from a speech corpus, each waveform unit in the initial set having a first time length;
generating a speech parameter trajectory by applying the set of HMMs to an input text;
constructing a unit lattice of candidate waveform units selected from the initial set of waveform units based at least on the speech parameter trajectory;
performing a normalized cross-correlation (NCC)-based search on the unit lattice to search for a sequence of candidate waveform units along a minimum concatenation cost path;
concatenating the sequence of candidate waveform units into a concatenated waveform sequence when the sequence of waveform units is found along the minimum concatenation cost path; and
generating a modified set of waveform units from the speech corpus when no sequence of candidate waveform units is found along the minimum concatenation cost path, each waveform unit in the modified set having a second time length that is less than the first time length.

11. The computer implemented method of claim 10, further comprising outputting the concatenated waveform sequence as synthesized speech.

12. The computer implemented method of claim 10, wherein the constructing includes using normalized distances between target units of an initial time length in the speech parameter trajectory and the set of waveform units to select the candidate waveform units.

13. The computer implemented method of claim 10, further comprising refining the set of HMMs via minimum generation error (MGE) training.

14. The computer implemented method of claim 10, further comprising applying a minimum voiced/unvoiced error algorithm to the speech parameter trajectory to compensate for voice quality degrades caused by noisy or flawed acoustic features in the speech corpus.

15. The computer implemented method of claim 10, further comprising pruning the unit lattice using at least one of context pruning, beam pruning, or histogram pruning.

16. A system, comprising:
one or more processors; and
a memory that includes a plurality of computer-executable components, the plurality of computer-executable components comprising:
a Hidden Markov Model (HMM) component to obtain a set of HMMs from a speech corpus;
a refinement component to refine the set of HMMs via minimum generation error (MGE) training to generate a refined set of HMMs; and
a trajectory generation component to generate a speech parameter trajectory by applying the refined set of HMMs to an input text.

17. The system of claim 16, further comprising a waveform segmentation component to segment one or more speech waveforms of the speech corpus into a set of waveform units.

18. The system of claim 17, further comprising a lattice construction component to construct a unit lattice of candidate waveform units selected from the set of waveform units based at least on the speech parameter trajectory.

19. The system of claim 18, further comprising a concatenation component to perform a normalized cross-correlation (NCC)-based search on the unit lattice to obtain a minimal concatenation cost sequence of candidate waveform units, and concatenate the minimum concatenation cost sequence of candidate waveform units into a concatenated waveform sequence.

20. The system of claim 18, wherein the speech parameter trajectory includes target units, and wherein the lattice construction component constructs the unit lattice by using normalized distances between the target units and the set of waveform units to select the candidate waveform units, each of the normalized distances measuring differences between line spectral pair (LSP) coefficients, gains, and fundamental frequencies of a target unit and a waveform unit.
